(19) United States
(12) Patent Application Publication
(10) Pub. No.: US 2002/0015617 A1
(43) Pub. Date: Feb. 7, 2002

(54) Device for attaching a flat gasket to a machine component

(76) Inventors: Kurt Schwenkel, Hulben (DE); Wilhelm Kullen, Hulben (DE)

Correspondence Address: Edward J. Timmer, Walnut Woods Center, 5955 W. Main Street, Kalamazoo, MI, 49009, US

(21) Appl. No.: 09/802,277

(22) Filed: Mar. 8, 2001

(30) Foreign Application Priority Data
Mar. 17, 2000 (DE) 100 13 130.1

(51) Int. Cl. F16D 1/00

(52) U.S. Cl. 403/329

(57) ABSTRACT

Flat gasket with a gasket plate for placement on a sealing surface of a machine component which has at least one hole opening into this sealing surface and extending approximately at right angles to the sealing surface, there being arranged on the gasket plate at least one securing element protruding transversely from the gasket plate and being insertable into the hole of the machine component for undetachable attachment of the flat gasket on the machine component, the securing element being provided at its circumference with at least one projection so designed for cooperation with the hole that withdrawal of the securing element from the hole is thereby at least rendered difficult.

The invention relates to a device for attaching a flat gasket to a machine component, the flat gasket having a gasket plate for placement on a sealing surface of the machine component.

On the assembly lines of the motor-vehicle industry, it would be advantageous if a gasket to be installed between the sealing surfaces of two machine components could be undetachably attached in a simple way to one of the two machine components and then handled together with this machine component. If the two machine components are attached to each other by means of screws and the flat gasket is thereby clamped between the sealing surfaces of the two machine components, the undetachable holding of the flat gasket on a machine component can be brought about by the screws being inserted into the one machine component and pushed or screwed through screw holes in the flat gasket. It is already known to provide the screw holes of the flat gasket with securing elements which engage the screw threads and thereby at least render withdrawal of the screws out of the screw holes of the flat gasket difficult.

The object underlying the invention was to provide a securing device for attachment of a flat gasket to the sealing surface of a machine component, which is simpler with respect to its design and its handling and is also not dependent upon interaction with assembly screws.

Departing from a flat gasket with a gasket plate for placement on a sealing surface of a machine component, which has at least one hole which opens into this sealing surface and extends approximately at right angles to the sealing surface, this object is accomplished in accordance with the invention with a device for attaching such a flat gasket to such a machine component, which is characterized by at least one securing element connected to the gasket plate, protruding transversely from the latter and being insertable into the hole of the machine component, the securing element having at its circumference at least one projection which is designed for such cooperation with the hole of the machine component that withdrawal of the securing element from this hole is thereby at least rendered difficult. As will be apparent from the following, the securing element may be a separate part or the securing element may be firmly attached to the gasket plate of the flat gasket.

The attachment of a flat gasket to the sealing surface of a machine component such that it is held undetachably by the latter is then possible in a simple way so that the handling of additional elements such as, for example, screws is dispensed with because the flat gasket only has to be placed on the machine component, i.e., the securing element inserted into the flat gasket and the machine component. In this connection, it is to be noted that machine components such as, for example, an intake pipe of an internal combustion engine, which is to be mounted on a cylinder head of the engine, always have to be provided with through-bores anyhow, so that there is virtually no additional expenditure involved in making an additional hole for insertion of the securing element of the flat gasket when machining such a machine component.

The projection of the securing element according to the invention could, for example, have the shape of a barb and be of rigid design so that upon inserting the securing element into the hole of the machine component, it digs slightly into the hole wall and thus renders withdrawal of the securing element from the hole difficult. In preferred embodiments of the flat gasket according to the invention, the securing element is, however, capable of undergoing elastic deformation at least in the area of the projection in the direction opposite to that direction in which the projection protrudes over the remaining circumference of the securing element.

For good positive anchoring of the securing element of the flat gasket on the machine component in question it may be recommendable to provide the hole of the machine component with a stepped wall so that the hole forms at a spacing from the sealing surface of the machine component a stop surface facing away from the sealing surface, and the projection of the securing element engages behind the stop surface when the flat gasket is placed in position. If the spacing of the projection of the securing element from the gasket plate, measured at right angles to the plane of the flat gasket, is then equal to or only slightly greater than the spacing of the stop surface from the sealing surface of the machine component, the flat gasket positioned on the latter will then be held on the machine component such that the gasket plate rests against the sealing surface of the machine component. If the hole is a through-bore of the machine component, i.e., if the machine component is penetrated by the hole so that the hole opens into a second machine component surface facing away from the sealing surface of the machine component, one will then expediently select the spacing of the projection of the securing element from the gasket plate of the flat gasket so that it is of the same size or only slightly larger than the length of the hole between the sealing surface of the machine component and its second surface.

In preferred embodiments of the flat gasket according to the invention, its securing element comprises two oppositely arranged projections facing away from each other in order to further increase the safety of the connection between flat gasket and machine component.

The gasket plate of flat gaskets generally possesses a sheet metal layer—the latter can form the gasket plate or a layer of a multilayer metal layer gasket, but also the sheet metal carrier of a so-called soft material gasket, which is provided on one side or both sides with a soft material covering. In these cases, the securing element can be produced particularly easily—for the area of the securing element protruding from the gasket plate can then be in the form of a sheet metal tongue. In a first type of flat gasket according to the invention, the sheet metal tongue is then integral with the said sheet metal layer and bent out of the latter, whereas in a second type of flat gasket according to the invention the sheet metal tongue can also be produced as a separate part and attached in a suitable way to the gasket plate, for example, by spot welding or adhesion. Such a sheet metal tongue can already be provided with one or several projections when being stamped out, and in preferred embodiments of the flat gasket according to the invention the sheet metal tongue has at its free end a head area whose shape corresponds to one of the following shapes: the shape of a barb, arrow, mushroom head or trapeze. In order that the projection or projections of the securing element will be able to yield transversely to the longitudinal direction of the securing element, so as to be able to easily insert the securing element into the hole of the machine component, whereupon the projection or projections assume their securing function, it is recommended to slot the sheet metal tongue in its longitudinal direction. When inserting the sheet metal tongue into the hole of the machine component, the longitudinal edges of the slot of the sheet metal tongue can then slide over each other or approach each other if the longitudinal edges of the slot extend in transversely spaced relation to each other.

However, not only is the securing element of a flat gasket according to the invention able to serve the purpose of undetachably holding the gasket on the machine component, it is also possible to so design the securing element that it positions the flat gasket precisely on the machine component and can absorb transverse forces. For this purpose, the maximum width of a positioning area of the securing element lying between the gasket plate and the free end area of the securing element, preferably of a foot of the securing element or the sheet metal tongue adjoining the gasket plate is dimensioned so as to correspond to the transverse spacing of those wall areas of the hole of the machine component against which the positioning area or the foot of the securing element or the longitudinal edges of the sheet metal tongue are to rest. If the hole is in the form of a bore and the securing element is in the form of a sheet metal tongue, the latter can really only position the flat gasket exactly in a single direction parallel to the plane of the gasket plate. In order to exactly position the flat gasket in two directions extending at right angles to each other and parallel to the plane of the gasket plate, it is recommended in this case to provide on the machine component two holes and on the flat gasket two sheet metal tongues whose planes extend transversely to each other and transversely to the plane of the gasket plate. Since, in principle, a single securing element is sufficient to hold the flat gasket undetachably on the machine component, for an exact positioning of the flat gasket on the machine component, the flat gasket can be designed such that there is arranged on its gasket plate a sheet metal tongue protruding transversely from the latter and serving only as positioning element, with the sheet metal tongue acting as securing element and the sheet metal tongue acting as positioning element each defining a plane, and these two planes extending approximately at right angles to the plane of the gasket plate and approximately at right angles to each other, and the machine component also having for the sheet metal tongue acting as positioning element an insertion hole which can also be a simple blind hole. Since the sheet metal tongue acting as positioning element only has to serve to position the flat gasket, its free end area can be rounded off so as to facilitate insertion of this sheet metal tongue into the associated hole of the machine component.

Attention is also called to the fact that the sheet metal tongues in question can also be twisted about their longitudinal axes, for example, through 90° between their foot and their free end and do not have to be of flat and level design.

A securing element of sleeve-type design can also be substituted for a sheet metal tongue as securing element. If the sleeve has, for example, an oval cross section, it can undergo such deformation upon insertion into the hole of the machine component that the maximum sleeve diameter is reduced in size and, consequently, a projection correspondingly attached thereto can be inserted into the hole in question. Embodiments are, however, preferred in which the securing element is slotted in its longitudinal direction in its area provided with the projection for the purpose of elastic reduction of its diameter. The sleeve can be slotted from its end adjacent to the projection, but it is also possible to provide the sleeve with slots from both of its ends, with the slots extending into the sleeve from one sleeve end being offset from each other in the circumferential direction of the sleeve in relation to the slots extending into the sleeve from the other sleeve end.

Such a sleeve-type securing element can be formed with two or more sheet metal tongues which protrude from the gasket plate and—seen at right angles onto the gasket plate—have an approximately circular-arc-shaped cross section. In other embodiments of the device according to the invention, the securing element is a sleeve produced as a separate part, preferably a plastic sleeve produced as an injection molded part.

With such a sleeve produced as a separate part, several embodiments of the device according to the invention can be implemented:

The sleeve can be firmly attached to the gasket plate and inserted into the hole of the machine component in such a way that the projection or projections provided on the sleeve engages or engage behind a stop surface formed by the machine component.

It is, however, also possible to so design the device according to the invention that the separate sleeve is inserted through a hole in the gasket plate into the hole of the machine component, and the sleeve has at both of its ends projections, one of which or some of which engages or engage behind the gasket plate and the other one of which or the other of which engages or engage behind a stop surface of the machine component. The projection or projections engaging behind the gasket plate must, of course, not impair the sealing function of the flat gasket. To ensure this, the gasket plate must have a recess, for example, in the form of a countersinking for receiving the projection, and/or the projection must be of such design and consist of such a material that it can undergo deformation (squeezing) during the tightening, i.e., when clamping the flat gasket between two sealing surfaces, so that it does not impair the sealing function of the flat gasket. If, as is often the case, the gasket plate is coated with an elastomeric material, there may, however, under certain circumstances, not be any necessity for deformability of the projection of the sleeve engaging behind the gasket plate as the projection can press into the coating in question during the clamping of the flat gasket. As will be apparent from the following, the projection or projections may be of such design that the projection or projections only partially engages or engage behind the gasket plate—in the case of only a single projection, this does not have to extend around the entire hole of the machine component, and in the case of several projections, gaps can be located between these (around the hole).

Sleeve-type securing elements can also be used to receive and align screws serving to clamp the flat gasket such that their threaded shafts extend at least approximately at right angles to the gasket plate of the flat gasket. For this case, it is recommended that the sleeve-type securing element be so designed that it can also undetachably hold such a screw, and, for this purpose, the inside diameter of the securing element is partially selected slightly smaller than the outside diameter of the threaded shaft so that the outside diameter of the threaded shaft is slightly larger than the clear inside diameter of the sleeve.

In the case of a sleeve-type securing element, the outside diameter in the projection-free area of the sleeve will generally be slightly smaller than the diameter of the hole of the machine component and the diameter of the hole of the gasket plate. Above all, when such a sleeve-type securing element is to serve to receive a threaded shaft of a screw, the sleeve can, however, also be clamped in the fashion of a dowel at the wall of the hole of the machine component when the slotted sleeve initially located with play in the hole of the machine component is widened by screwing the threaded shaft into the sleeve and thus clamped in the hole of the machine component. In this case, one could even dispense with providing the sleeve with one or several projections, and, therefore, such embodiments are also to be considered as falling within the present invention.

Further improvements of the device according to the invention will be apparent from the attached claims.

Several preferred embodiments of a device according to the invention shown in the appended drawings will be described hereinbelow. The drawings show:

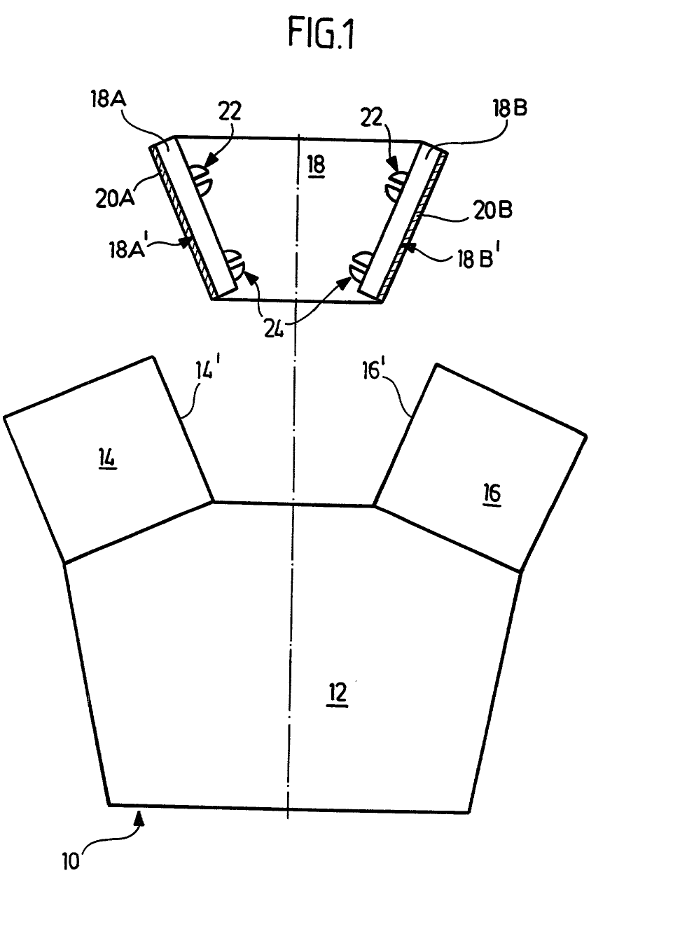

FIG. 1 a schematic front view of an internal combustion engine which is designed as a V-engine and of an intake pipe with two flat gaskets undetachably held thereon, which is to be mounted on this engine;

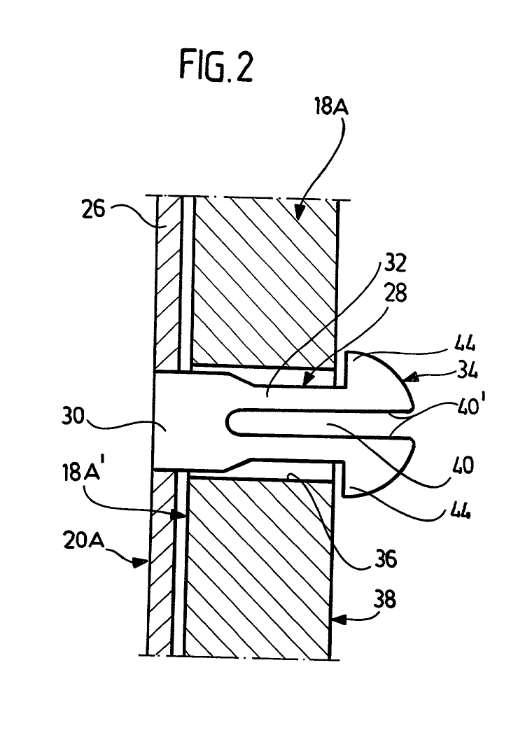

FIG. 2 a section through a part of a machine component and a part of a flat gasket undetachably held thereon;

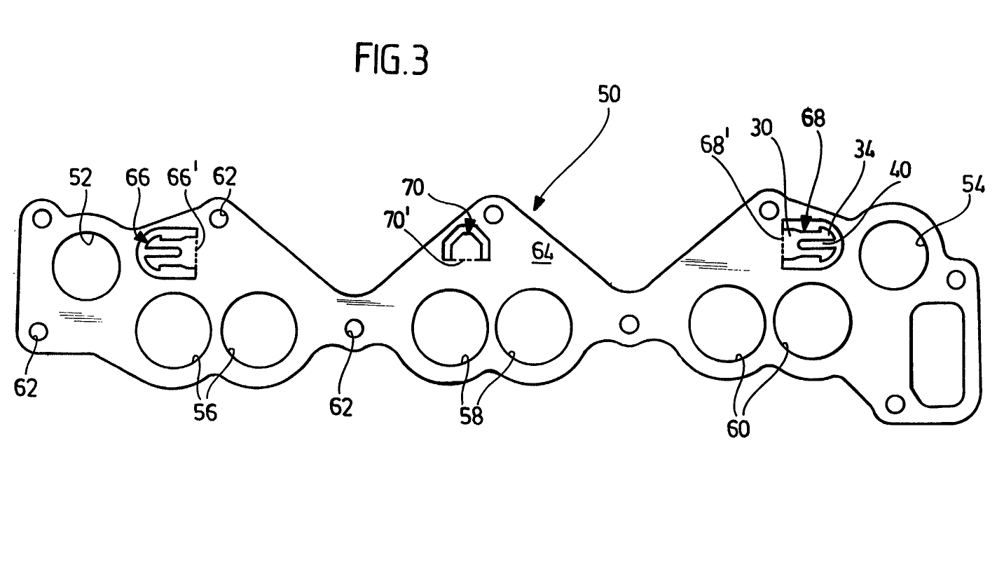

FIG. 3 a plan view of one of the flat gaskets shown in FIG. 1, but with the securing and positioning elements formed on this flat gasket still lying in the plane of the gasket plate of this flat gasket;

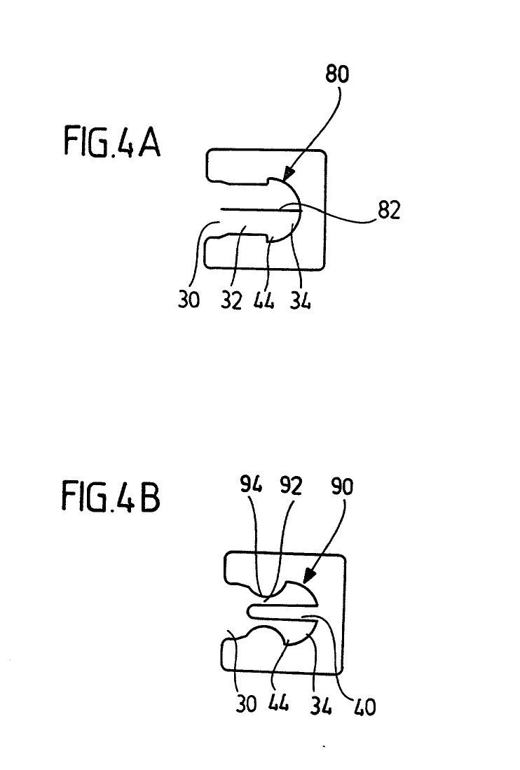

FIGS. 4A and 4B two further embodiments of a securing element according to the invention;

FIG. 5 a section corresponding to FIG. 2 through a further embodiment of the device according to the invention with a securing element in the form of a sleeve;

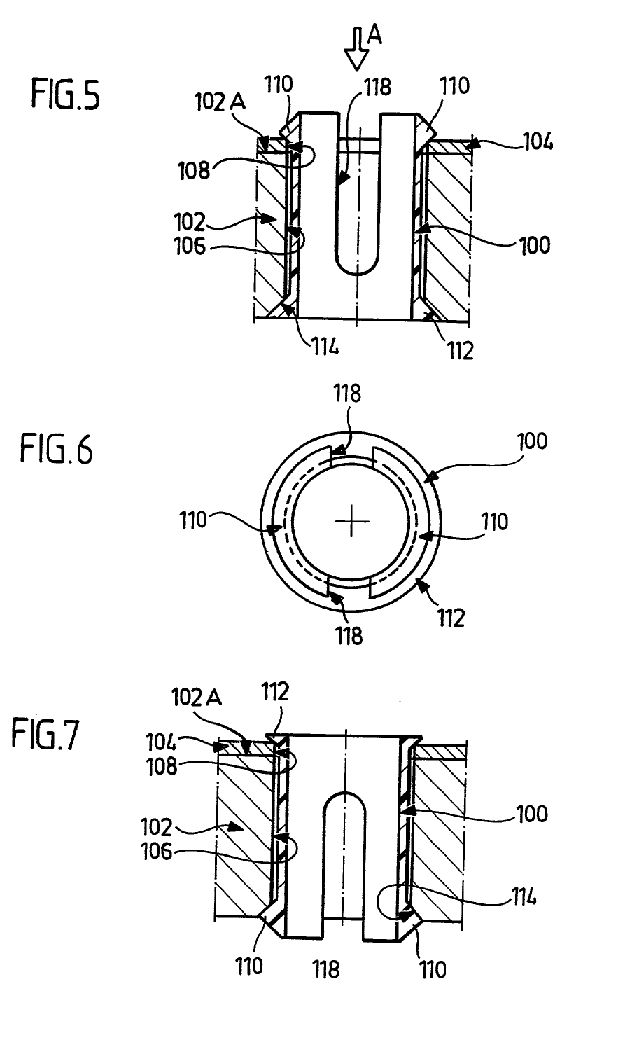

FIG. 6 a plan view of the securing element shown in FIG. 5, viewed in the direction of arrow A from FIG. 5;

FIG. 7 an illustration corresponding to FIG. 5 of a further embodiment of the device according to the invention, which uses the same sleeve as the embodiment shown in FIG. 5, but with a different use of the sleeve;

FIG. 8 a section corresponding to FIG. 2 through a further embodiment of the device according to the invention; and

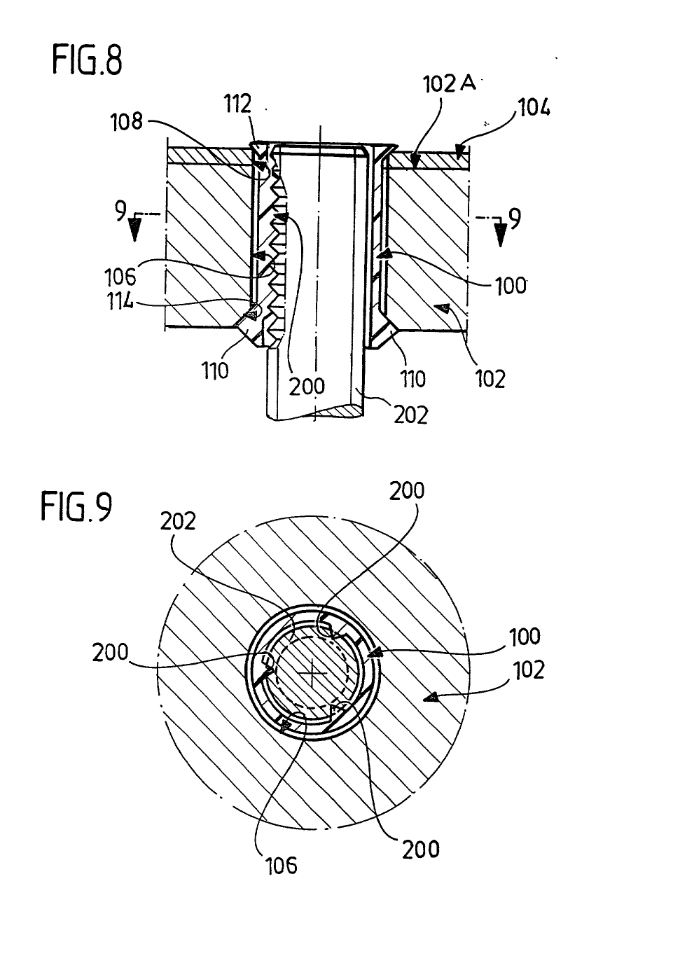

FIG. 9 a section through this embodiment according to line 9-9 in FIG. 8.

FIG. 1 shows an internal combustion engine 10 designed as a V-engine, namely a V6-engine. The crankcase of the engine has been designated 12, the left cylinder head of the engine 14 and the right cylinder head 16. Furthermore, FIG. 1 shows schematically an intake pipe 18, which is to be installed between the cylinder heads 14 and 16 and comprises a left and a right intake pipe flange 18A and 18B, respectively, which are to be attached by means of screws, not shown, to the left cylinder head 14 and the right cylinder head 16, respectively. Sealing surfaces of the cylinder heads and the intake pipe flanges, which are to be sealed off relative to one another, have been designated 14′, 16′, 18A′ and 18B′. A flat gasket 20A is attached to the intake pipe flange 18A, a flat gasket 20B to the intake pipe flange 18B. After assembly of the intake pipe 18 on the cylinder heads 14 and 16, the flat gasket 20A is clamped between the sealing surfaces 18A′ and 14′, the flat gasket 20B between the sealing surfaces 18B′ and 16′. Each of the two flat gaskets 20A and 20B has at its disposal two securing elements 22 and 24, with the aid of which the flat gaskets are undetachably held and possibly also positioned on the intake pipe flanges, as will be apparent from the following.

FIG. 2 shows a section through a part of the intake pipe flange 18A and through a part of the flat gasket 20A. The flat gasket 20A is a single-layer sheet metal gasket whose gasket plate, which is to be placed against the sealing surface 18A′ of the intake pipe flange 18A, has been designated 26. Integral with this gasket plate 26 is a sheet metal tongue forming a securing element 28 according to the invention, which has been formed by being partially stamped out of the gasket plate 26 and then bent at right angles out of the gasket plate. The securing element 28 has a foot 30 adjoining the gasket plate 26, a neck 32 tapered in relation to the foot, and a head area 34 forming the free end of the securing element.

For engagement of the securing element 28, the intake pipe flange 18A has a hole 36, which is a through-bore, which extends from the sealing surface 18A′ to a second, opposite surface 38 of the intake pipe flange. The hole 36 could, however, also be, for example, a slot-shaped opening in the intake pipe flange 18A.

The width of the foot 30 of the securing element 28 is only slightly smaller than the diameter of the hole 36, while the maximum width of the head area 34 is greater than the hole diameter. In order that the head area 34 can be inserted through the hole 36, the securing element 28 is provided with a longitudinal slot 40 whose longitudinal edges 40′ extend at such a transverse spacing from one another that the head area 34 of the securing element 28 can be pushed through the hole 36, whereby the neck 32 undergoes elastic deformation. In order that the foot 30 of the securing element 28 can ensure that the flat gasket 20A is exactly positioned on the intake pipe flange 18A, it is recommended that the longitudinal slot 40 be allowed to terminate before the foot 30.

To facilitate the pushing of the securing element 28 into the hole 36, the head area 34 of the securing element is rounded off at its right end in accordance with FIG. 2. In order that the flat gasket 20A is held undetachably on the intake pipe flange 18A, the head area 34 forms two projections 44 arranged opposite each other and protruding in opposite directions, which are of barb-shaped design, project beyond the hole 36 when the flat gasket is attached to the intake pipe flange and abut on the second surface 38 of the intake pipe flange if an attempt is made to remove the flat gasket 20A from the intake pipe flange 18A. In the embodiment of the securing element 28 shown in FIG. 2, its head area is of approximately mushroom head shape, but it could also be in the shape of an arrow or in the form of a single barb—in this case one of the projections 44 would be eliminated and possibly also the longitudinal slot 40.

The securing element 28 shown in FIG. 2 is of such dimensions that the spacing of the projections 44 from the gasket plate 26 is only slightly larger than the spacing of the sealing surface 18A′ from the opposite surface 38 of the intake pipe flange 18A. From FIG. 2 it will, however, also be clear that the securing element 28 could be of shorter dimensions if the hole 36 were, for example, a stepped bore which widens so as to receive the head area 34 and forms a stop surface for the projections 44. Furthermore, the hole 36 could also be a blind hole which opens into the sealing surface 18A′, and onto the wall of which the securing element hooks—in this case it would be expedient to modify the head area 34 of the securing element such that it has the shape of an arrow or the shape of a barb.

Since the foot 30 of the securing element 28 engages at least almost fittingly in the hole 36, is not weakened by the longitudinal slot 40 and directly adjoins the gasket plate 26 of the flat gasket 20A, the foot 30 can serve to absorb transverse forces by which the flat gasket 20A would otherwise be shifted relative to the intake pipe flange 18A parallel to the sealing surface 18A′ thereof.

As will be shown hereinbelow, the longitudinal slot 40 could be replaced by a simple cut which enables, when inserting the securing element 28 into the hole 36, the two parts of the neck 32 and the head area 34 to be pushed over one another in order to put the head area 34 through the hole 36.

FIG. 3 shows a flat gasket 50 according to the invention with two water through-openings 52 and 54, each with two intake openings 56, 58 and 60 for each of the three cylinders of the one cylinder head and screw through-openings 62 for those screws with which the one intake pipe flange is mounted on the one cylinder head and the flat gasket is thereby clamped between the sealing surfaces of intake pipe flange and cylinder head.

The flat gasket 50 shown in FIG. 3 is also a single-layer sheet metal gasket. However, FIG. 3 could also show a sheet metal layer of a multilayer flat gasket, as has already been explained hereinabove.

Two securing elements 66 and 68 in the form of sheet metal tongues have been stamped out of the gasket plate 64 of the flat gasket 50. In the illustration of FIG. 3, these still lie in the plane of the gasket plate 64, but before assembly of the gasket are bent at right angles out of the plane of the gasket plate—the bending lines have been designated 66′ and 68′, respectively. As the securing elements 66 and 68 are of essentially the same design as the securing element 28 shown in FIG. 2, there is no need for any further description of the securing elements 66 and 68.

As the two planes which are defined by the sheet metal tongues forming the securing elements extend parallel to each other after the securing elements 66 and 68 have been bent out of the gasket plate 64, the flat gasket 50 shown in FIG. 3 also has a positioning element 70 at its disposal, which is to serve not for undetachable holding, but only for exact positioning of the flat gasket. The positioning element 70 is also a sheet metal tongue obtained by stamping it out of the gasket plate 64, and it is to be bent out of the plane of the gasket plate about a bending line 70′ such that the plane defined by the positioning element 70 extends at right angles to the plane of the gasket plate 64 and at right angles to those planes which define the upwardly bent securing elements 66 and 68. Of course, the machine component to which the flat gasket 50 is to be attached, for example, the intake pipe flange 18A, is also to have not only a hole corresponding to the hole 36 shown in FIG. 2 for each of the securing elements 66 and 68, but also an additional hole for at least almost fitting engagement of the upwardly bent positioning element 70, whose maximum width in the vicinity of the bending line 70′ is to be equal to or only slightly smaller than the diameter of the associated hole, and its free head area is to be rounded off or at least of such configuration that it tapers towards the end of the sheet metal tongue.

FIGS. 4A and 4B show two further variants of a securing element 80 and 90, respectively, according to the invention. The securing element 80 shown in FIG. 4A differs from the securing element 28 shown in FIG. 2 essentially only in that the longitudinal slot 40 of the securing element according to FIG. 2 is replaced by a simple cut 82 so that the two lugs of the securing element 80 produced by the cut can be pushed over each other when the securing element is introduced into a hole of the associated machine component. The deformation of the two lugs resulting from this pushing over each other should, however, if possible, be an elastic deformation so that the two lugs spring back into their initial position shown in FIG. 4A when the head area of the securing element 80 moves out of the machine component hole.

The securing element 90 shown in FIG. 4B differs from the securing element 28 shown in FIG. 2 essentially only in that the neck 92 of the securing element has been additionally weakened by lateral cut-outs 94 so as to facilitate compression of the head area of the securing element.

FIGS. 5 and 6 show an embodiment of the device according to the invention, in which at least one securing element is in the form of a sleeve 100, which could also be a metallic sleeve, but has preferably been produced as an injection molded plastic sleeve. This sleeve serves to secure a flat gasket on a machine component 102 whose sealing surface has been designated 102A. Of the flat gasket only parts of a gasket plate 104 are shown in FIG. 5. For engagement of the sleeve 100 the machine component 102 has a hole 106 in the form of a through-bore, and the gasket plate 104 has a hole 108 whose diameter is preferably approximately the same size as the diameter of the hole 106. On the outer circumference of the sleeve 100 in the area of one sleeve end there are formed several, in the illustrated case two, diametrically opposed, first projections 110, and in the area of the other sleeve end at least one second projection 112—this second projection in the illustrated embodiment is a ring-shaped collar or flange. The hole 106 of the machine component 102 is preferably provided in its end area facing away from the sealing surface 102A with a widening 114 which can receive the second projection 112 and forms a stop therefor. Between the projections 110 and 112 the outside diameter of the sleeve 100 is preferably only very slightly smaller than the inside diameter of the hole 106.

The sleeve 100 is slotted in the longitudinal direction from its first, according to FIG. 5 upper end (on which the first projections 110 are formed) but the slots 118 extend only over part of the length of the sleeve 100.

In accordance with the invention, the first projections 110 are sloped at least at their upper side according to FIG. 5, such that the sleeve 100 can be easily inserted from below according to FIG. 5 into the machine component 102 and the gasket plate 104. Once the sleeve 100 has reached its position shown in FIG. 5, the first projections 110 engage behind the gasket plate 104. Furthermore, the lower sleeve end according to FIG. 5 is flush with the machine component 102.

In the embodiment shown in FIGS. 5 and 6, the securing element, namely the sleeve 100, is not firmly attached to the flat gasket or its gasket plate 104, but instead forms a separate part also in the assembled state. If, in this embodiment, the machine component not shown in FIG. 5, which is to be pressed against the gasket plate 104, does not have a recess or a hole for receiving that area of the sleeve 100 which projects over the gasket plate 104, the sleeve 100 must be modified such that it is somewhat shorter than shown in FIG. 5 and engages behind the gasket plate 104 only with absolutely flat first projections, which upon clamping the flat gasket can undergo such deformation (squeezing) by the second machine component, not shown, that they do not impair the sealing function of the flat gasket. For this purpose, it may prove advantageous for the first projections (measured in the circumferential direction of the sleeve) to be of very short design.

The same reference numerals were used for the embodiment of the device according to the invention shown in FIG. 7 as in FIGS. 5 and 6 as the embodiment according to FIG. 7 differs from that according to FIGS. 5 and 6 essentially only in that the sleeve 100 can be firmly attached to the gasket plate 104 and inserted according to FIG. 7 from above into the machine component 102. However, in the embodiment shown in FIG. 7, the second projection 112 may have to be capable of undergoing such deformation or squeezing that it does not impair the sealing function of the flat gasket. For this reason, it may be recommendable to replace a ring-shaped projection 112 by two or more projections which (in the circumferential direction of the sleeve 100) form large gaps between them.

FIGS. 8 and 9 show a further embodiment of the device according to the invention, which is highly similar to the embodiments shown in FIGS. 5 to 7, and, therefore, the same reference numerals have been used in FIGS. 8 and 9 as in FIGS. 5 to 7.

As will be apparent, above all, from FIG. 9, in the embodiment according to FIGS. 8 and 9 there are, however, formed on the inner circumference of the sleeve 100 plastic ribs which extend in the longitudinal direction of the sleeve and serve to hold and align a threaded shaft 202 of a screw. The clear inside diameter of the sleeve 100 defined by the ribs 200 is preferably somewhat smaller than the outside diameter of the thread of the threaded shaft 202 so that the screw thread digs slightly into the ribs 200 when inserting or screwing the screw into the sleeve 100.

In the embodiment shown in FIGS. 8 and 9, the sleeve 100 may be of such design that it only expands when introducing the threaded shaft 202 into the sleeve such that the sleeve and hence the flat gasket or its gasket plate 104 is secured on the machine component 102.

What is claimed is:

1. Device for attaching a flat gasket to a machine component, said flat gasket comprising a gasket plate for placement on a sealing surface of said machine component, said machine component having at least one hole opening into said sealing surface and extending approximately at right angles to said sealing surface, characterized by at least one securing element (28) connected to said gasket plate (26), protruding transversely from said gasket plate (26) and being insertable into said hole (36), said securing element (28) being provided at its circumference with at least one projection (44) provided for such cooperation with said hole that withdrawal of said securing element from said hole is thereby at least rendered difficult.

2. Device as defined in claim 1, characterized in that the securing element (28) is capable of undergoing deformation at least in the area of the projection (44) in the direction opposite to that in which said projection protrudes.

3. Device as defined in claim 1, characterized in that the securing element (28) comprises two projections (44) arranged opposite each other and pointing away from each other.

4. Device as defined in claim 1, with the machine component having at least two holes opening into its sealing surface and arranged in transversely spaced relation to each other, characterized by at least two securing elements (66, 68) which are arranged in transversely spaced relation to each other, each for engagement in one of said holes.

5. Device as defined in claim 1, characterized in that the securing element is of sleeve-type design.

6. Device as defined in claim 5, characterized in that the securing element is slotted in its longitudinal direction in the area thereof which is provided with the projection for the purpose of elastic reduction of its diameter.

7. Device as defined in claim 6, characterized in that the securing element is slotted from its end adjacent to the projection.

8. Device as defined in claim 7, characterized in that the length of the slotted area is less than the total length of the securing element.

9. Device as defined in claim 6, characterized in that the securing element comprises two slots arranged opposite each other.

10. Device as defined in claim 5, characterized in that the securing element is a sleeve which is produced as a separate part.

11. Device as defined in claim 10, characterized in that the sleeve is a plastic sleeve in the form of an injection molded part.

12. Device as defined in claim 10, characterized in that the gasket plate has a hole enabling insertion of the sleeve into the gasket plate, and the sleeve is provided with at least a second projection for engaging behind the gasket plate or the machine component at the end of the sleeve facing away from the first projection thereof serving for the securing.

13. Device as defined in claim 12, with the hole of the machine component forming at a spacing from the sealing surface thereof a stop surface facing away from said sealing surface, characterized in that the spacing of the second projection from the first projection, measured in the longitudinal direction of the sleeve, corresponds approximately to the spacing of the stop surface from the sealing surface of the machine component plus the thickness of the gasket plate.

14. Device as defined in claim 12, characterized in that in the projection-free area of the sleeve, the outside diameter thereof corresponds to the diameter of the hole of the gasket plate.

15. Device as defined in claim 10, characterized in that in the projection-free area of the sleeve, the outside diameter thereof corresponds to the diameter of the hole of the machine component.

16. Device as defined in claim 5, characterized in that the securing element is designed so as to receive and align a threaded shaft of a screw.

17. Device as defined in claim 16, characterized in that the clear inside diameter of the securing element is slightly smaller than the outside diameter of the threaded shaft.

18. Device as defined in claim 1, characterized in that the securing element is firmly attached to the gasket plate.

19. Device as defined in claim 1, with the gasket plate defining a plane of the flat gasket, and the hole forming at a spacing from the sealing surface of the machine component a stop surface facing away from the sealing surface, characterized in that the spacing of the projection (44) from the gasket plate (26), measured at right angles to the flat gasket plane, is at least equal to the spacing of the stop surface (38) from the sealing surface (18A′) of the machine component (18A).

20. Device as defined in claim 1, with the hole penetrating the machine component and opening into a second machine component surface facing away from the sealing surface of the machine component, characterized in that the spacing of the projection (44) from the gasket plate (26) is at least equal to the length of the hole (36) between the sealing surface (18A′) of the machine component (18A) and the second surface (38) thereof.

21. Device as defined in claim 1, characterized in that the area (30, 32, 34) of the securing element (28) protruding from the gasket plate (26) is formed by at least one sheet metal tongue.

22. Device as defined in claim 21, characterized in that the sheet metal tongue (28) has at its free end a head area (34) whose shape corresponds to one of the following shapes: the shape of a barb, an arrow, a mushroom head or a trapeze.

23. Device as defined in claim 21, characterized in that the maximum width of a foot (30) of the sheet metal tongue (28) adjoining the gasket plate (26) corresponds to the transverse spacing of those wall areas of the hole (36) of the machine component (18A) against which the longitudinal edges of the foot (30) of the sheet metal tongue are to rest in order to position the flat gasket (20A).

24. Device as defined in claim 21, characterized in that the sheet metal tongue (28) is slotted in its longitudinal direction.

25. Device as defined in claim 24, characterized in that the longitudinal edges (40′) of the slot (40) of the sheet metal tongue (28) extend in transversely spaced relation to each other.

26. Device as defined in claim 21, with the gasket plate comprising a plate-like sheet metal layer, characterized in that the sheet metal tongue (28) is integral with the sheet metal layer (26) and is bent out of the latter.

27. Device as defined in claim 21, characterized in that two sheet metal tongues (66, 68) are provided, in that each of the two sheet metal tongues (66, 68) defines one plane, and in that the two planes extend approximately at right angles to the plane of the gasket plate (64) and approximately at right angles to each other.

28. Device as defined in claim 21, with the machine component comprising at a transverse spacing from the hole for engagement of the securing element a hole serving to position the flat gasket and opening into the sealing surface of the machine component, characterized in that there is arranged on the gasket plate (64) a sheet metal tongue protruding transversely from the latter and serving as positioning element (70), the sheet metal tongue (66, 68) acting as securing element and the sheet metal tongue (70) acting as positioning element each defining a plane, and in that these two planes extend approximately at right angles to the plane of the gasket plate (64) and approximately at right angles to each other.

29. Device as defined in claim 28, with the gasket plate comprising a plate-like sheet metal layer, characterized in that the sheet metal tongue (70) acting as positioning element is integral with the sheet metal layer (64) and is bent out of the latter.

30. Device as defined in claim 28, characterized in that the free end area of the sheet metal tongue (70) acting as positioning element is rounded off.

31. Device as defined in claim 28, characterized in that the maximum width of a foot of the sheet metal tongue (70) acting as positioning element, which adjoins the gasket plate (64), corresponds to the transverse spacing of those wall areas of the hole of the machine component serving to receive the sheet metal tongue acting as positioning element against which the longitudinal edges of the sheet metal tongue are to rest in order to position the flat gasket.
